(19) United States
(12) Patent Application Publication
(10) Pub. No.: US 2011/0188980 A1
(43) Pub. Date: Aug. 4, 2011

(54) GETTIE UP THAR

(76) Inventor: JoAnn Pumroy, Alamo, TX (US)

(21) Appl. No.: 13/006,427

(22) Filed: Jan. 14, 2011

Related U.S. Application Data
(60) Provisional application No. 61/299,995, filed on Jan. 31, 2010.

(51) Int. Cl. B60P 1/00; B60P 1/43; B66D 3/04

(52) U.S. Cl. 414/538; 414/812

(57) ABSTRACT

A luggage loading system for use with land vehicles comprising: a pulley assembly; a hinged ramp inclinable onto a back of a vehicle; and a cable assembly. The pulley assembly comprises an axle providing a rotator for at least one wheel, the wheel is used for translational rotation whereby a mechanical advantage may be applied to the luggage (or other liftable item) via a user manipulating the cable assembly. The mechanical advantage is used to load and/or unload luggage. The pulley assembly comprises a fixed class one pulley; wherein the pulley is used to change direction of an applied force permitting a user to pull-load the luggage up the slope of the hinged ramp using the mechanical advantage as opposed to lifting the luggage.

### CROSS-REFERENCE TO RELATED APPLICATION

The present application is related to and claims priority from prior provisional application Ser. No. 61/299,995, filed Jan. 31, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of loading and more specifically relates to a luggage loading system for use with land vehicles, herein entitled Gettie Up Thar.

### 2. DESCRIPTION OF THE RELATED ART

Individuals in modern society may regularly travel for business or pleasure. When traveling these individuals may use vehicles to transport themselves and their luggage between locations. When loading a vehicle with groceries, luggage, and other items, it may prove difficult for some individuals to lift the items into the trunk or cargo area of their vehicle. This task may be especially difficult for those that have a weak back or are otherwise impaired. Lifting heavy items can cause injury to the neck, back, and arms. Without assistance, it may be virtually impossible for some individuals to transport the necessary items. Lifting assistance is often not conveniently available and may be an expensive service when used.

Lifting vehicles and jacks may be used to lift heavy items; however these devices may be cumbersome and not practical for use with passenger vehicles. Further, pickers and booms may be used with trucks, but are not typically suited for use with enclosed vehicles. These lifting means may also damage luggage if not properly attached or manipulated. Elderly or handicapped persons may not be able to carry luggage based on the present alternatives available, which may be undesirable.

Various attempts have been made to solve the above-mentioned problems such as those found in U.S. Pat. Nos. 5,934,863 to Gregory S. Beck; 5,911,465 to Kazuhisa Yamamoto et al; 7,618,024 to Jesse Constant; and 2006/0045677 to Steven M. Garfield et al. This prior art is representative of vehicle luggage loaders. None of the above inventions and patents, taken either singly or in combination, is seen to describe the invention as claimed.

Ideally, a luggage loading system for use with land vehicles should be user-friendly, convenient to use and store, yet would operate reliably and be manufactured at a modest expense. Thus, a need exists for a reliable luggage loading system to avoid the above-mentioned problems.

### BRIEF SUMMARY OF THE INVENTION

In view of the foregoing disadvantages inherent in the known luggage loading art, the present invention provides a novel luggage loading system for use with land vehicles. The general purpose of the present invention, which will be described subsequently in greater detail is to provide convenience and ease of loading luggage into vehicles.

A luggage loading system for use with land vehicles is disclosed herein comprising: at least one pulley assembly; a hinged ramp inclinable onto a back of a vehicle thereby providing a bridger (sloped bridging means); and a cable assembly. The pulley assembly comprises an axle providing a rotator for at least one wheel, the wheel is used for translational rotation whereby a mechanical advantage may be applied to the luggage (or other liftable item) via the cable assembly. The mechanical advantage may be used to load and/or unload the luggage. The pulley assembly preferably comprises a fixed class one pulley; wherein the pulley is used to change direction of an applied force permitting a user to pull-load the luggage up the slope of the hinged ramp (using the mechanical advantage as opposed to lifting the luggage).

The cable assembly may comprise a handle and clipping mechanism in preferred embodiments. The handle of the cable assembly may comprise a comfort-handgrip that is disposed on a looped portion (looped on itself and affixed to itself via crimp or other suitable fastening means) of the cable of the cable assembly. The vehicle preferably comprises at least one seat having a seat-mounted clip-attacher; wherein the clipping mechanism of the cable assembly and/or pulley may be attached as a fixed mounting point. The clipping mechanism may comprise a carabiner clip. The clip-attacher and luggage may be joined via the cable assembly; wherein the cable assembly is hand-operable by the user in a horizontally-sloped orientation (manipulated up slope of inclined ramp) when the cable assembly is attached to the seat via the clip-attacher as an anchoring means. The cable assembly is removably insertable into the pulley assembly to pull-load the luggage up the inclined ramp for placement in an interior of the vehicle (van, truck, car or other suitable vehicle). The luggage loading system is disassemblable and is storable within an enclosed or unenclosed vehicle.

Additionally a kit is described including the pulley assembly; the hinged ramp; the cable assembly; a carrying case; and a set of user instructions.

A method of using the luggage loading system for use with land vehicles is also disclosed herein comprising the steps of: coupling a (hingable) ramp to a rear portion of the land vehicle (or non-land vehicle); assembling a cable assembly with a pulley assembly; securing the cable assembly to at least one item to be lifted and to the land vehicle; loading the item into an interior (or exterior in other embodiments) of the land vehicle; unsecuring the cable assembly from the item(s) (to which it is attached); uncoupling the ramp from the rear portion of the land vehicle and folding the hinged ramp; then disassembling and storing the luggage loading system for storage within a storage case.

The present invention holds significant improvements and serves as a luggage loading system for use with land vehicles. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Gettie Up Thar, constructed and operative according to the teachings of the present invention.

FIG. 1 shows a perspective view illustrating an item of luggage hooked to a luggage loading system according to an embodiment of the present invention.

FIG. 2 is a perspective view illustrating the luggage loading system in an in-use condition according to an embodiment of the present invention of FIG. 1.

FIG. 3 is a perspective view illustrating a cable assembly as used with a pulley assembly of the luggage loading system according to an embodiment of the present invention of FIG. 1.

FIG. 4A is a perspective view illustrating an alternate cable assembly as used with the pulley assembly of the luggage loading system according to an embodiment of the present invention of FIG. 1.

FIG. 4B is a perspective view illustrating a clip-attacher as used with the cable assembly of FIG. 4A of the luggage loading system according to an embodiment of the present invention of FIG. 1.

FIG. 5 is a flowchart illustrating a method of use for the luggage loading system, entitled Gettie Up Thar according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a loading device and more particularly to a luggage loading system 100 for use with land vehicles 120 as used to improve the convenience and ease for travelers when loading luggage 130 into vehicles 120.

Generally, Gettie Up Thar 102 is a pulley system 112 (including pulley assembly 110) designed to assist users in loading suitcases, packages, and other such heavy items (luggage 130) into cargo space 122 of vehicle 120. The device substantially eliminates back strain that is commonly associated with lifting weighty items. The instant system can be used by virtually anyone who is looking for an easier and safer method for loading vehicle 120. Gettie Up Thar 102 is designed to help individuals efficiently load items into cargo space 122 of land vehicle 120 which may include trucks, cars, vans, buses. This system preferably comprises a steel pulley 114, ramp 140, and cable 152 with a handle and clipping mechanism 180.

Ramp 140 may be constructed out of wood, plastic, or other suitable material. Ramp 140 may be hinged so that it can be folded compactly upon itself (back-to-back) and stored in vehicle 120. It should be appreciated that hinge(s) work in conjunction with a rod or other means whereby hinges may rotate about a centerline axis, allowing ramp 140 to fold.

Cable 152 may include a handle on one end and at least one clipping mechanism 180, or hook on the opposite end. Pulley 114 may be attached to the back of car seat 124 using an additional hook or other means of attachment. Alternately pulley 114 may be connected elsewhere along cable assembly 150. Cable 152 may be threaded through pulley system 112 for use.

Clipping mechanism 180 may be attached to the item that is being loaded into vehicle 120. The item may be placed on ramp 140 and the individual may use the handle to pull the item up ramp 140, using its gradual slope to move the item in an upward direction instead of directly lifting it. Once the item is at the top of ramp 140, luggage 130 (or other item) may be positioned in vehicle 120. After use, the components may be disassembled and stored in vehicle 120. It should be appreciated that the present system may be used in conjunction with virtually any loadable item that is capable of being attached to cable 152.

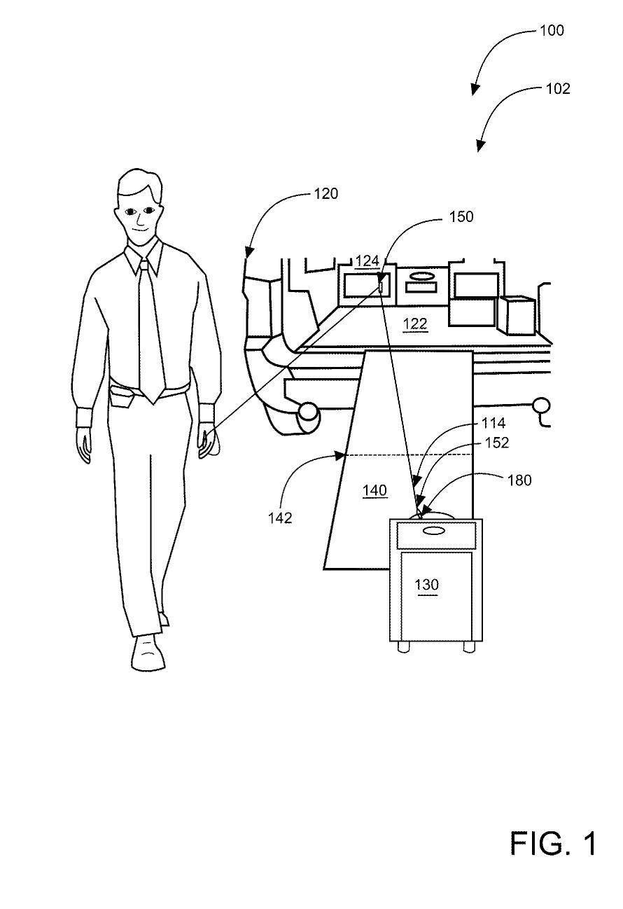

Referring now more specifically to the drawings by numerals of reference there is shown in FIG. 1, a perspective view illustrating an item of luggage 130 hooked to luggage loading system 100 according to an embodiment of the present invention.

Luggage loading system 100 within the present embodiment shown comprises: at least one pulley assembly 110; at least one ramp 140; and at least one cable assembly 150, as discussed briefly above. Cable assembly 150 is preferably removably insertable into pulley assembly 110 to pull luggage 130 up ramp 140 for placement in vehicle 120.

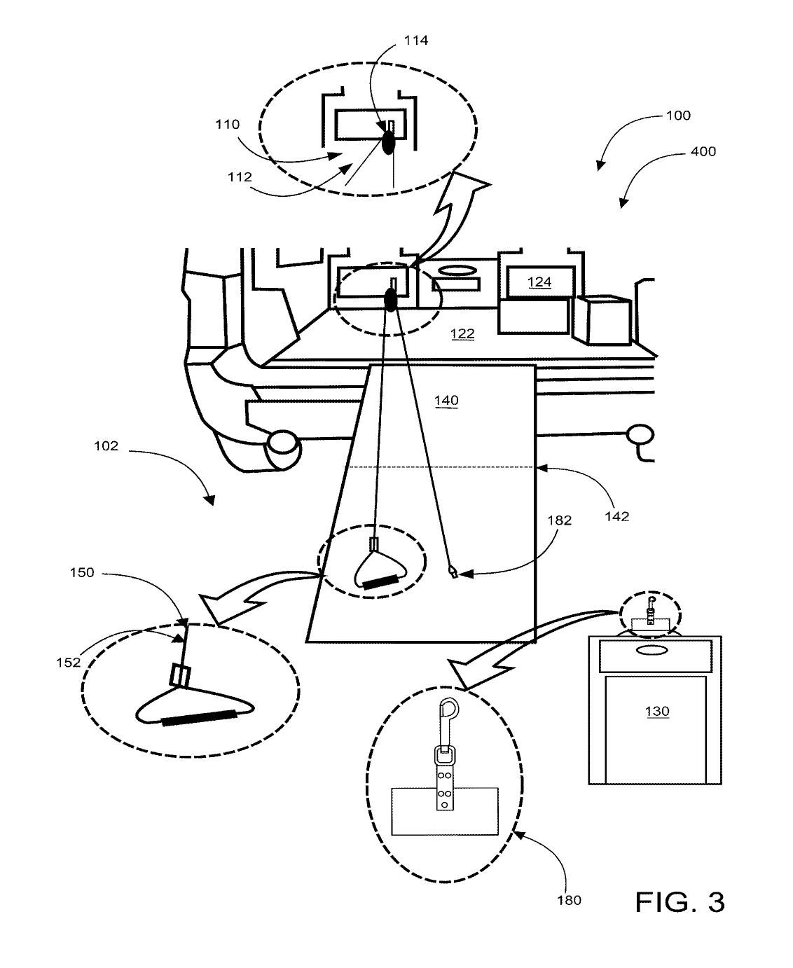

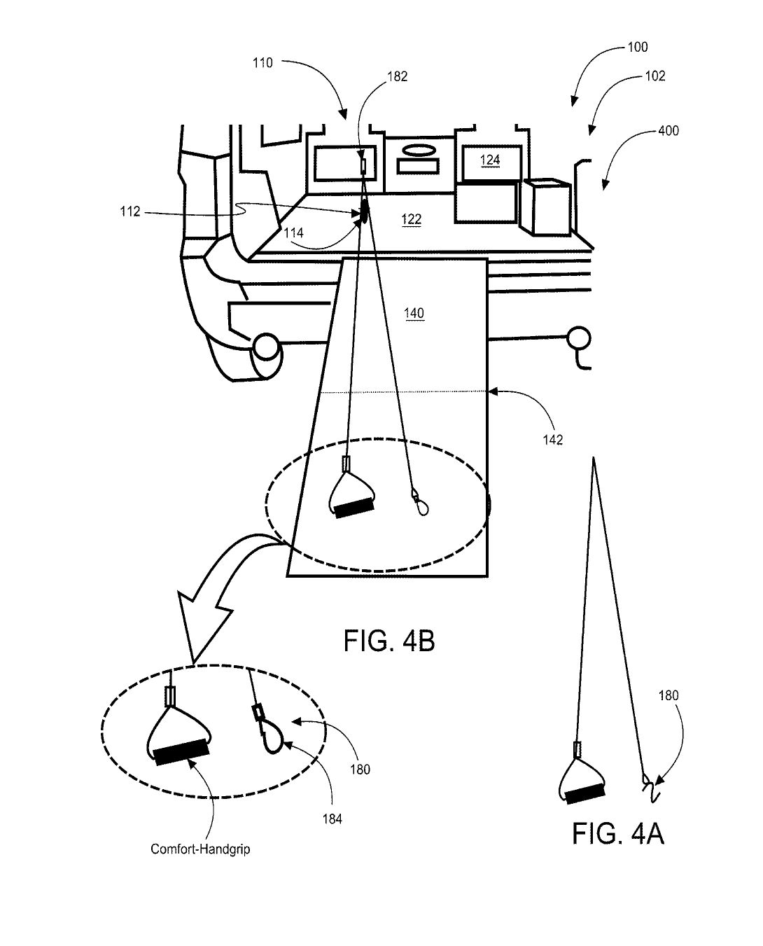

Pulley assembly 110 of luggage loading system 100 (as shown in FIGS. 3 and 4B) preferably comprises an axle providing a rotator for at least one wheel, wherein the wheel is used for translational rotation whereby a mechanical advantage may be applied to luggage 130 via pulling on cable assembly 150. The mechanical advantage may be used as an effective levering means to load luggage 130. In a similar fashion luggage loading system 100 may be used as a mechanical advantage to unload luggage 130 (used as a means of controlling speed of slope decent). In this way luggage 130 may be loaded by the user tension-pulling on cable 152 and luggage 130 may be unloaded by the user allowing cable 152 to ‘unwind’ using gravitational pull to move luggage 130 downwardly along ramp 140. Those with ordinary skill in the art will now appreciate that upon reading this specification and by their understanding the art of attaining and manipulating mechanical advantages as provided by various pulleys as described herein, methods of pulley use will be understood by those knowledgeable in such art.

In certain embodiments pulley 114 comprises a fixed class one version of pulley 114. In other embodiments pulley 114 may comprise a movable class two version of pulley 114. In yet other versions pulley 114 may comprise a compound version of pulley 114. In this way the present invention may use various leveraging/levering means to provide the desired mechanical advantage. Pulley 114 may be used to change the direction of an applied force (luggage 130) thereby permitting user to pull-load luggage 130 via ramp 140 using the mechanical advantage. The mechanical advantage realized by use of pulley system 112 provides an efficient means whereby a user may load luggage 130 without assistance from another. It should also be noted that it is preferable that luggage 130 comprises wheels (and wheels suitably oriented in relation to the pull-effort) to reduce friction while ramp-loading thereby decreasing the amount of effort required by the user. Upon reading this specification, it should be appreciated that, under appropriate circumstances, considering such issues as user preferences, design preference, structural requirements, marketing preferences, cost, available materials, technological advances, etc., other pulley arrangements and materials such as, for example, plastic, composite, ferrous, non-ferrous, alloys, etc., may be sufficient.

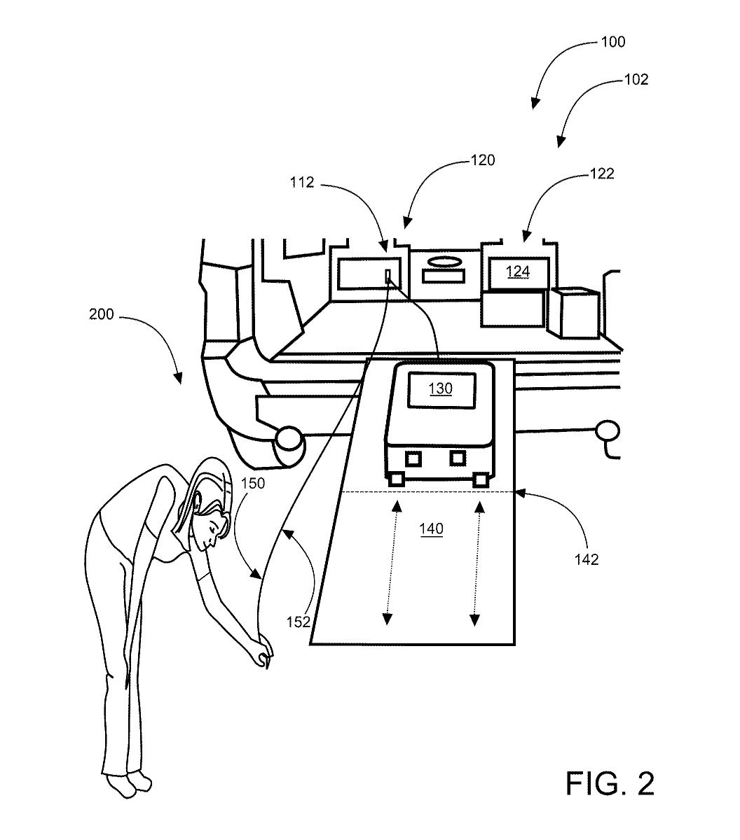

As aforementioned, cable assembly 150 of luggage loading system 100 preferably comprises at least one cable 152. Cable assembly 150 preferably comprises a handle and clipping mechanism 180, as shown. Cable assembly 150 is hand-operable with substantial ease by the user in a (generally) horizontally-sloped orientation when cable assembly 150 is attached to vehicle seat 124 via clip-attacher 182. Vehicle seat 124 serves to provide a fixed holder (anchor point) and may be a hide-away style in certain embodiments. The handle of cable assembly 150 in certain embodiments comprises a comfort-handgrip (called out in FIG. 4B) that is disposed on a looped portion of cable assembly 150. The comfort-handgrip serves to provide a surface area increaser whereby the handle doesn't ‘cut into’ the hand of the user when in in-use condition 200, as illustrated in FIG. 2.

Referring now to FIG. 2, a perspective view illustrating luggage loading system 100 in an in-use condition 200 according to an embodiment of the present invention of FIG. 1.

Luggage loading system 100, as shown, allows placement of luggage 130 into an interior of land vehicle 120. Additionally illustrated is that ramp 140 may be set up or otherwise coupled to land vehicle 120 during in-use condition 200. Ramp 140 preferably comprises at least one hinge (hereby enabling hinged ramp 142). Vehicle 120 as shown comprises at least one vehicle seat 124 having at least one clip-attacher 182. Upon reading this specification, it should be appreciated that, under appropriate circumstances, considering such issues as user preferences, design preference, structural requirements, marketing preferences, cost, available materials, technological advances, etc., other anchoring arrangements such as, for example, various attachment points in or on land vehicle 120, etc., may be sufficient.

Referring now to FIG. 3, a perspective view illustrating cable assembly 150 as used with pulley assembly 110 of luggage loading system 100 according to an embodiment of the present invention of FIG. 1.

Clip-attacher 182 and luggage 130 may be joined via cable assembly 150 in a series and/or parallel relationship (depending on which version of pulley 114 is used). In this way the user may move/manipulate luggage 130 via direct and/or indirect means. When luggage 130 has been placed in the desired location, luggage loading system 100 is then optionally disassemblable and is readily storable within an enclosed or non-enclosed vehicle 120.

Referring also now to FIG. 4A and FIG. 4B, FIG. 4A showing a perspective view illustrating an alternate cable assembly 150 as used with pulley assembly 110 of luggage loading system 100 according to an embodiment of the present invention of FIG. 1 and FIG. 4B is a perspective view illustrating clip-attacher 182 as used with cable assembly 150 of FIG. 4A.

Clipping mechanism 180 of cable assembly 150 may comprise a carabiner clip 184 or other form of clipping means such as that shown in FIG. 3—that may be attached/removably-attached to luggage 130. Clipping mechanism 180 may be easily clipped and unclipped from luggage 130 thereby increasing the relative efficiency whereby the present invention can be used. Other clipping means may be used in other applications according to user-preference as discussed above. Luggage loading system 100 may be sold as kit 400 comprising the following parts: pulley assembly 110; hinged ramp 142; at least one cable assembly 150; a carrying case; and a set of user instructions. Luggage loading system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, those for use with various vehicle styles; including more or less components, customized parts, different color/design combinations, various types of fasteners, parts may be sold separately, etc., may be sufficient.

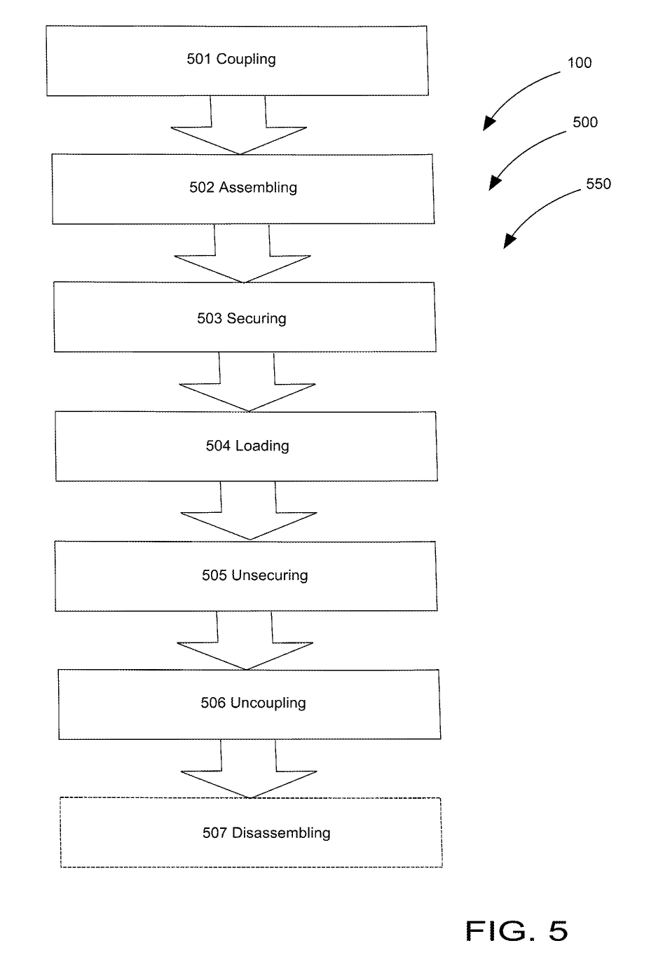

Referring now to FIG. 5, flowchart 550 illustrating method of use 500 for luggage loading system 100, entitled Gettie Up Thar 102 according to an embodiment of the present invention of FIGS. 1-4.

Method of use 500 for luggage loading system 100 for use with land vehicles 120 may comprise the steps of: step one 501 coupling ramp 140 to a rear portion of land vehicle 120 (or non-land vehicle); step two 502 assembling cable assembly 150 with pulley assembly 110; step three 503 securing cable assembly 150 to at least one item (luggage 130 or other) and to land vehicle 120; step four 504 loading the item into an interior (cargo space 122) of land vehicle 120; step five 505 unsecuring cable assembly 150 from at least one item (to which it is attached); step six 506 uncoupling ramp 140 from the rear portion of land vehicle 120 and folding hinged ramp 142 (folded ramp 140); and step seven 507 disassembling and storing luggage loading system 100 for storage in cargo space 122 of land vehicle 120 within a storage case. Grocery loading may be accomplished in the following way: open up a suit case (luggage 130) and slide the heavy packages off the grocery cart into luggage 130 then load as mentioned above. Many other items envisioned may be loaded in this way or the present invention may be attached to the items ‘as-is’.

It should be noted that step seven 507 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claim:

1. A luggage loading system comprising:
at least one pulley assembly;
a ramp;
a cable assembly; and
wherein said cable assembly is removably insertable into said pulley assembly to pull said luggage up said ramp for placement in a vehicle.

2. The luggage loading system of claim 1 wherein said pulley assembly comprises an axle providing a rotator for at least one wheel, said wheel is used for translational rotation whereby a mechanical advantage may be applied to said luggage via said cable assembly.

3. The luggage loading system of claim 2 wherein said mechanical advantage is used to load said luggage.

4. The luggage loading system of claim 2 wherein said mechanical advantage is used to slope-unload said luggage up said ramp.

5. The luggage loading system of claim 2 wherein said pulley comprises a fixed class one pulley.

6. The luggage loading system of claim 2 wherein said pulley comprises a movable class two pulley.

7. The luggage loading system of claim 2 wherein said pulley comprises a compound pulley.

8. The luggage loading system of claim 2 wherein said pulley is used to change direction of an applied force permitting a user to pull-load said luggage via said ramp using said mechanical advantage.

9. The luggage loading system of claim 1 wherein said cable assembly comprises a handle and clipping mechanism.

10. The luggage loading system of claim 1 wherein said placement is in an interior of said vehicle.

11. The luggage loading system of claim 1 wherein said ramp comprises a hinge.

12. The luggage loading system of claim 1 wherein said vehicle comprises at least one seat having a clip-attacher holder.

13. The luggage loading system of claim 12 wherein said clip-attacher and said luggage are joined via said cable assembly.

14. The luggage loading system of claim 1 wherein said luggage loading system is disassemblable and is storable within an enclosed said vehicle.

15. The luggage loading system of claim 13 wherein said cable assembly is hand-operable by at least one user in a horizontally-sloped orientation when said cable assembly is attached to said seat via said clip-attacher.

16. The luggage loading system of claim 9 wherein said handle of said cable assembly comprises a comfort-handgrip that is disposed on a looped portion of said cable assembly.

17. The luggage loading system of claim 9 wherein said clipping mechanism of said cable assembly comprises a carabiner clip.

18. A luggage loading system for use with land vehicles comprising:
at least one pulley assembly;
a hinged ramp inclinable onto a back of a vehicle thereby providing a bridger;
a cable assembly; and
wherein said pulley assembly comprises an axle providing a rotator for at least one wheel, said wheel is used for translational rotation whereby a mechanical advantage may be applied to said luggage via said cable assembly;
wherein said mechanical advantage is usable to load and/or unload said luggage;
wherein said pulley assembly comprises a fixed class one pulley;
wherein said pulley is used to change direction of an applied force permitting a user to pull-load said luggage via said hinged ramp using said mechanical advantage;
wherein said cable assembly comprises a handle and at least one clipping mechanism;
wherein said handle of said cable assembly comprises a comfort-handgrip that is disposed on a looped portion of said cable assembly;
wherein said vehicle comprises at least one seat having a clip-attacher;
wherein said clipping mechanism of said cable assembly comprises a carabiner clip;
wherein said clip-attacher and said luggage are joined via said cable assembly;
wherein said cable assembly is hand-operable by said user in a horizontally-sloped orientation when said cable assembly is attached to said seat via said clip-attacher;
wherein said cable assembly is removably insertable into said pulley assembly to pull said luggage up said hinged ramp for placement in an interior of said vehicle; and
wherein said luggage loading system is disassemblable and is storable within an enclosed said vehicle.

19. A luggage loading system for use with land vehicles comprising a kit including said pulley assembly; said hinged ramp; said cable assembly; a carrying case; and a set of user instructions.

20. A method of using a luggage loading system for use with land vehicles comprising the steps of:
coupling a ramp to a rear portion of said land vehicle;
assembling a cable assembly with a pulley assembly;
securing said cable assembly to at least one item and to said land vehicle;
loading said item into an interior of said land vehicle;
unsecuring said cable assembly from said at least one item;
uncoupling said ramp from said rear portion of said land vehicle; and
disassembling and storing said luggage loading system.
